(19) United States
(12) Patent Application Publication
(10) Pub. No.: US 2024/0139843 A1
(43) Pub. Date: May 2, 2024

(54) METHOD AND ELECTRODE FOR MACHINING COMPONENTS BY ELECTROCHEMICAL MACHINING

(71) Applicant: MTU Aero Engines AG, München (DE)

(72) Inventors: Roland Huttner, München (DE); Markus Zeis, München (DE); Nicole Feiling, München (DE)

(73) Assignee: MTU Aero Engines AG, München (DE)

(21) Appl. No.: 17/769,349

(22) PCT Filed: Oct. 6, 2020
(86) PCT No.: PCT/DE2020/000233

§ 371 Date: Apr. 15, 2022

(30) Foreign Application Priority Data
Oct. 17, 2019 (DE) 10 2019 216 048.4

(51) Int. Cl. B23H 3/04; B23H 3/10

(52) U.S. Cl. CPC B23H 3/04; B23H 3/10

(57) ABSTRACT

The invention relates to a method for the electromechanical machining of a component with at least one electrode which has a first working face with an outer contour which is shaped so as to form a gap complementary to a surface, to be produced by the electrochemical machining, of the component and which has a second working face which is able to be arranged at an edge of the produced surface of the component. In the method, first of all the component is provided, and the first working face of the electrode is positioned in a first machining position with respect to the component. Then, the component is machined with the first working face in order to produce the surface, before the machining of the component with the first working face is ended at a predetermined position. Subsequently, the component is machined with the second working face of the electrode.

### BACKGROUND OF THE INVENTION

The invention relates to a method for the electrochemical machining of a component with at least one electrode that has a first working face with an outer contour, which is shaped so as to form a gap complementary to a surface to be produced by the electrochemical machining of the component, and that has a second working face for the removing of a structure formed during the production of the surface.

In a method for the electrochemical machining (elysing) of a component, such as electrochemical machining (ECM: “electrochemical machining”) or precise electrochemical machining (PECM: “precise electrochemical machining”), an electrically conductive metal is removed by an electrochemical process. In this case, a cathode (electrode, tool) is moved relative to an anode (component) and is guided thereby “into” or “through” the component. At the same time, an electrolyte is supplied into the gap remaining between the cathode and the anode and, in particular, serves for transporting away the process products that are formed, such as, in particular, metal hydroxides. The desired surface predetermined by the electrode is thereby formed on the component.

Electrochemical machining makes it possible to produce precise component geometries. Accordingly, the electrodes have a precise geometry that corresponds to the intended machining and are correspondingly guided precisely relative to the machined component. During the machining of the components, this results in the formation of exact machined edges or machined borders as well as corresponding edge structures that form at the machined edge, such as, for example, sharp edges. Depending on the function, it is often desired that the transition from the electrochemically machined surfaces to the surfaces of a component that adjoin them do not have any hard edges or broken or slightly rounded-off edges caused by the production, but rather have strongly rounded-off edges. In order to break or else to round off the edges or the transitions, an additional manufacturing step is usually required, often in the form of an additional material-removing method step.

### SUMMARY OF THE INVENTION

An object of the present invention that hereby ensues is to propose an improved method for the electrochemical machining of a component. To be further provided is an electrode and a device for carrying out the method. This is achieved in accordance with the invention by the teaching of the independent claims. Advantageous embodiments of the invention are the subject of the dependent claims.

For achieving the object, a method is proposed for the electrochemical machining of a component with at least one electrode that has a first working face with an outer contour, which is shaped so as to form a gap complementary to a surface to be produced by the electrochemical machining of the component. The electrode further has a second working face, which can be arranged at an edge of the produced surface of the component, in order to remove at least one structure formed at the edge thereof during the production of the surface. The method comprises the following method steps:
providing the component;
positioning the first working face of the electrode in a first machining position opposite the component;
machining the component with the first working face by use of a first set of machining parameters for producing the surface;
ending the machining of the component with the first working face,
   at a predetermined position and/or
   positioning of the second working face of the electrode in a predetermined position opposite the component;
machining the component with the second working face by use of a second set of machining parameters for removing the structure;

Accordingly, the electrode has a first working face and a second working face, wherein the first working face serves for producing the intended surface of the component and the second working face is used subsequently for the production of the intended surface of the component, in order to remove a structure that is formed on the edge of the produced surface, in particular by the preceding machining step. Depending on the application, the electrode can also have two or more first working faces for the machining of one surface or two surfaces or a plurality of surfaces that is or are to be produced, whereby a working face of the electrode can also be multipart in design.

The electrode further has a second working face, which can be arranged at an edge of the produced surface of the component, in order to remove at least one structure formed at its edge during the production of the surface. What is involved here are, in particular, such structures that are formed by the machining of material that is arranged adjacent to the produced surface, such as, in particular, sharp edges or edges that have ridges. Depending on the application, the electrode can also have two or more second working faces for the machining of edge regions of one produced surface, two produced surfaces, or a plurality of produced surfaces, wherein a second working face of the electrode can also be multipart in design.

After providing the component that is to be machined, the electrode is positioned with its first working face in a first machining position relative to the component and then it is moved with the first working face and by use of a first set of machining parameters opposite the component, in particular along a predetermined machining track in order to produce the intended surface. Such a first set of machining parameters comprises, in particular, the speed of advance (for example, constant and/or oscillating) and the voltage applied between the component (anode) and the electrode (cathode) as well as, in particular, the time course thereof (for example, constant, changing, or oscillating or increasing or decreasing) and the supply of electrolyte to the gap remaining between the first working face and the machined surface of the component, whereby the supply of electrolyte can be delivered, in particular, also as a pulsating stream.

The machining of the component with the first working face of the electrode is ended after the surface has been produced. The machining is ended, in particular, at a predetermined position to which the electrode has been moved by the machining advance. It is equally possible to end the machining of the component at a position that has no local relation to a following machining step. Accordingly, the second working face of the electrode can be positioned, after ending of the machining with the first working face and/or by way of an additional positioning step, at the predetermined position opposite the component. In this case, the predetermined position corresponds to the (start) machining position of the second working face for removing a structure that is formed on the edge of the already produced surface.

This is followed by machining the component with the at least one second working face by use of a second set of machining parameters for removing the structure. Such a second set of machining parameters also comprises, in particular, a movement of advance, which, if need be, can be oscillating, and the voltage applied between the component (anode) and the electrode (cathode) as well as, in particular, the time course thereof and the supply of electrolyte to the gap remaining between the second working face and the machined surface of the component. In particular, the second working face is arranged at the electrode in such a way that, at the end of the machining movement of the first working face for the production of the surface, it is positioned at the component at the predetermined position with respect to the component, so that the machining for removing a structure that is formed on the edge is possible, in particular without any further or at least without any more complex positioning of the electrode relative to the component.

The proposed method makes it possible to remove sharp edges or similar structures at the edges, such as transitions of electrochemically machined surfaces to other surfaces of a component, with a single clamping and by use of the same electrode in one electrochemical machining step and, in particular, a subsequent or second electrochemical machining step, in particular to break or round off such edges. The machining course here is similar to the conventional method for producing a surface, whereby, in the case of the proposed method, the forward advance device of the electrode can be stopped at a suitable position and the machining of the component can, if necessary, be continued after an additional positioning of the electrode with the second working face by use of, in particular, a second parameter set. One possible parameter of the second parameter set is, for example, a slight linear oscillation at the edge of the surface that has been produced beforehand. The required electrolyte can be delivered, for example, in a countercurrent method in the entire machining process and can thus be delivered counter to the direction of advance of the electrode.

In one embodiment of the method, the electrode has at least one third working face, which is arranged parallel to the second working face at another edge of the produced surface of the component and by means of which at least one structure that is formed at the additional edge during the production of the surface can be removed, whereby the component is machined simultaneously with the second working face and the third working face of the electrode. In this way, it is possible to remove at least one structure that is formed at the additional edge of the surface during the production of the surface. Accordingly, the third working face is arranged parallel to the second working face at a predetermined position, in particular at the edge of the produced surface, so that the machining for the removal of a structure that is formed, in particular, at the additional edge of the surface is possible without additional positioning of the electrode relative to the component. In particular, the machining of the component with the third working face is produced by use of a third parameter set, the parameter values of which are in accord with those of the second parameter set at least in regard to the electrode movement.

In one embodiment for carrying out the method, two electrolyte supply circuits are utilized, whereby the machining of the component with the first working face of the electrode is supplied with electrolyte by the first electrolyte supply circuit and the machining of the component with the second and/or third working face of the electrode is supplied with electrolyte by the second electrolyte supply circuit. In this embodiment, the electrolyte for producing the surface is delivered by means of the first electrolyte supply circuit, in particular in the countercurrent method, to the first working face and thus counter to the direction of advance of the electrode and, for the removal of the structure(s) that are formed at the edge of the surface, by means of the second electrolyte supply circuit to the gap lying between the component and the second and/or third working face. In this embodiment, the electrolyte for supply of the machining by means of the second and/or third working face need not be delivered through the machining gap of the first working face, where there exists the danger of etching the already produced surface during machining by the second and/or third working face. Consequently, in this embodiment, the electrolyte of the second electrolyte supply circuit can flow freely away. In this case, in order to carry out the method, it is also possible to provide three electrolyte supply circuits, so that the machining of the component with the second working face of the electrode can be supplied with electrolyte by a second electrolyte supply circuit and the machining of the component with the third working face of the electrode can be supplied by a third electrolyte supply circuit.

In a further aspect of the invention, an electrode for the electrochemical machining of a component is proposed, which, for example, can be utilized for a method for the electrochemical machining of a component in accordance with one or more aspects of the previously described method. The proposed electrode has a first working face with an outer contour that is shaped so as to form a gap complementary to a surface to be produced by the electrochemical machining of the component. Furthermore, the electrode has a second working face, which is provided for arrangement at an edge of the produced surface of the component in order to remove at least one structure that is formed at this edge, in particular, during the production of the surface.

The electrode has at least one first working face and at least one second working face, wherein a first working face is provided for the production of a predetermined surface of the component and a second working face is used, in particular, after the production of the predetermined surface of the component, in order to remove a structure that is formed at the edge of the produced surface. Depending on the application, the electrode also has two or more first working faces for the machining of one surface or two or more surfaces that is or are to be produced, whereby a working face of the electrode can also be multipart in design. Furthermore, the electrode has at least one second working face, which is able to be arranged at the edge of the produced surface of the component in order to remove at least one structure formed at the edge of the surface during its production. What is involved here are, in particular, such structures that are formed by the machining of material that is arranged adjacent to the produced surface, such as, in particular, sharp edges or edges that have ridges. Depending on the application, the electrode can also have two or more second working faces for the machining of edge regions of one produced surface, two produced surfaces, or a plurality of produced surfaces, whereby a second working face of the electrode can also be multipart in design.

In one embodiment, the electrode has at least one third working face, which is provided for arrangement at another edge of the produced surface of the component, in order to remove at least one structure that is formed at this additional edge, in particular during the production of the surface. In this way, it is possible to use the electrode also to remove additional structures of the component that are formed, in particular, at the edge of the produced surface.

In one embodiment of the electrode for the electrochemical machining of a component, the second working face and the third working face are correspondingly arranged apart from each other at a distance between the edge and a further edge, so that structures that are formed there are removed in parallel by the electrode. In particular, the third working face is arranged at the electrode in such a way that, in each case, it can be positioned parallel to the second working face at a predetermined position at the edge of the produced surface, so that a machining of the component on, in particular, at least two edges of the produced surface is possible without any additional further positioning of the electrode with respect to the component.

In one embodiment of the electrode, an electrically nonconductive and, in particular, protective anodic region extends between the second working face and the third working face. Such an electrically nonconductive region can, for example, be formed from a nonconductive coating of the electrode or by a protective anode or, for example, from a nonconductive material that is formed from a nonconductive element that is produced and arranged on the electrode. Accordingly, it is not possible for current to flow between this electrically nonconductive region of the electrode and the component. During the electrochemical machining, therefore, no machining of material takes place at a component relative to an electrically nonconductive region of the electrode. Accordingly, it is possible by means of an electrically nonconductive region to delimit or to define the electrochemically machined surface of a component.

In one embodiment of the electrode, a distance of separation between the second working face and the third working face corresponds to the extent of the machining by way of the first working face. With such an electrode, it is possible simultaneously to machine the edges at two sides of the preceding machining by the first working face, as a result of which, in particular, it is possible to save time and costs.

In one embodiment, electrolyte delivery channels are formed in the electrode, through which electrolyte can be delivered to the second working face and/or third working face. By means of electrolyte delivery channels passing inside of the electrode, it is possible to deliver the electrolyte required for the machining directly to one working face or a plurality of working faces that is or are arranged on the electrode, so that the electrolyte is guided reliably to the machined sites. Furthermore, it is also thereby possible to simplify the delivery of the flow of electrolyte outside of the electrode.

In a third aspect of the invention an arrangement for the electrochemical machining of a component is proposed, which can be utilized for carrying out a method in accordance with one or more aspects of the previously described method. Furthermore, the arrangement has an electrode with at least one or more of the features of the previously described electrode. The arrangement further has a machining mount in which at least one region of the component that is to be machined can be arranged at least in part and which has a rinsing chamber and an electrolyte supply line that can be connected to an electrolyte circuit for delivery of electrolyte to the first working face of the electrode.

The embodiment of the electrode and the optional features thereof correspond to those of the electrode described above in detail. It is possible to arrange on the machining mount at least in part at least one region of the component that is to be machined. In particular, such a region of the component that is to be machined can be arranged in a rinsing chamber of the machining mount. An electrolyte delivery line that can be connected to an electrolyte circuit delivers electrolyte to the first working face of the electrode, in particular into a gap that is arranged between the component to be machined and the electrode. Here, the rinsing chamber of the machining mount surrounds at least in part the gap arranged between the component to be machined and the electrode. In particular, the electrolyte delivery line is designed in such a way that the electrolyte delivery channels deliver electrolyte to the rinsing chamber and there into the machining gap, where, as it flows through the gap, in addition to supporting the electrical conductivity thereof, it also assists particularly in carrying away process products that are formed. The rinsing chamber is designed, in particular, also to guide the flow of spent electrolyte after the machining, in particular in order to take it away from the machining mount and, for example, to deliver it to a spent electrolyte disposal.

In a fourth aspect of the invention a device for the electrochemical machining of a component is proposed, which, in particular, can be utilized for carrying out a method in accordance with one or more aspects of the previously described method. The proposed device has:
at least one component mount for mounting a component that is to be machined in the device;
an electrode with at least one working face arranged on it for machining a component;
a drive device for moving at least one electrode opposite the component that is to be machined;
a supply device for supplying the electrode with energy and for supplying electrolyte to at least one gap between the electrode and the component; and
a control device for controlling the device for the electrochemical machining of a component.

In this case, the proposed device has an electrode that is designed in accordance with one or more features of the previously described electrode and/or the device has an electrode arrangement like the one previously described.

A device designed in accordance with the invention makes it possible to carry out the proposed method and accordingly to remove sharp edges or similar structures on edges, such as transitions of electrochemically machined surfaces to other surfaces of a component with one clamping and using the same electrode in one electrochemical machining step, particularly in one subsequent or second electrochemical machining step and, in particular, to break them or round them off.

### BRIEF DESCRIPTION OF THE DRAWING FIGURES

Further features, advantages, and possible applications of the invention ensue from the following description in connection with figures. Shown are:

FIG. 1 shows a schematic illustration of an exemplary arrangement according to the invention for carrying out the method according to the invention for the electrochemical machining of a component, in a partial sectional depiction;

FIG. 2A shows the schematic illustration of the exemplary arrangement according to the invention from FIG. 1 in a partial sectional depiction during the carrying out of a further method step;

FIG. 2B shows a detail of the illustration from FIG. 2A;

FIG. 3 is a schematic illustration of another exemplary arrangement according to the invention for carrying out the method according to the invention for the electrochemical machining of a component in a partial sectional depiction; and

FIG. 4 is a schematic illustration of a flow chart of the method according to the invention.

### DESCRIPTION OF THE INVENTION

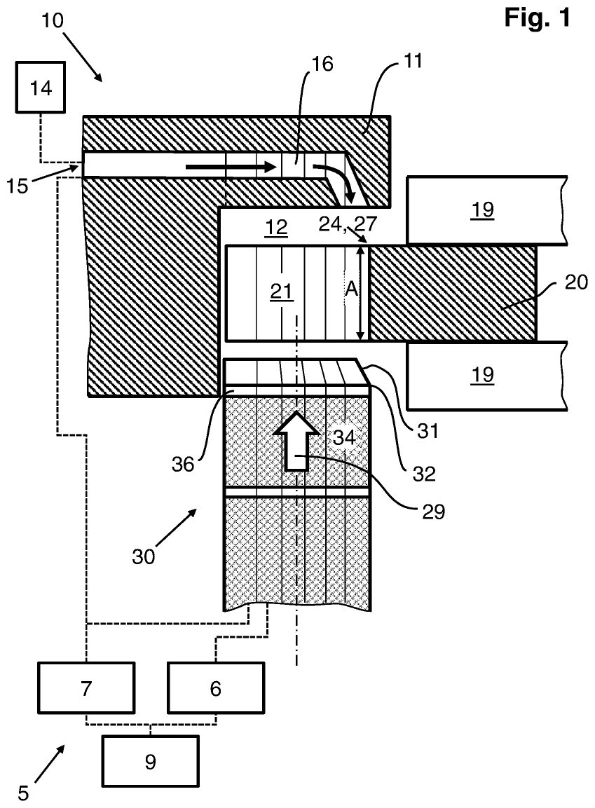

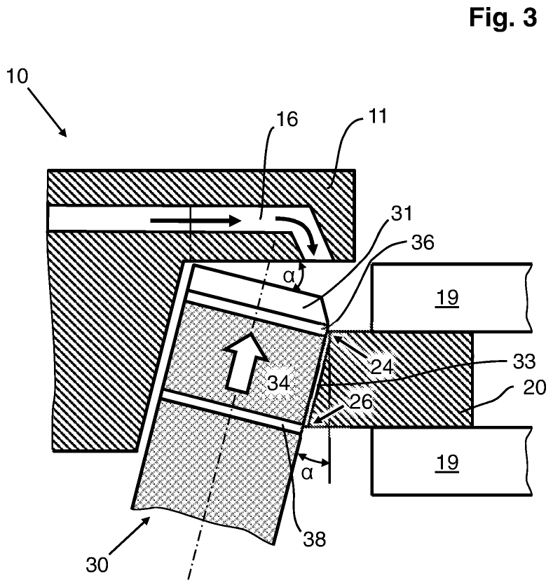

FIG. 1 shows a schematic illustration of an exemplary arrangement 10 according to the invention for carrying out the method according to the invention for the electrochemical machining of a component 20 arranged in a clamping device 19 in a partial sectional depiction. In this case, the illustration shows the arrangement 10 after the production of the surface 21 by electrochemical machining. The arrangement 10 has an electrode 30, which has a first working face 31 with an outer contour 32 that is shaped so as to form a gap 33 (see FIG. 3) complementary to a surface 21 of the component 20 that can be produced with the electrode 30 by electrochemical machining. The light edges depicted in the surface 21 and the first working face 31 serve to highlight the three-dimensional extension of the first working face 31 or of the produced surface 21.

The electrode 30 further has a second working face 36, which is provided so as to be able to be arranged on an edge 24 of the produced surface 21 of the component 20, in order to remove at least one structure 27 at an edge 24 that, in particular, is formed during the production of the surface 21. In the illustrated exemplary embodiment, the structure 27 has a surface 21 that is produced on the edge 24 of the electrochemically produced surface 21 and is to be rounded off.

The arrangement further has a machining mount 11, in which the region of the component 20 that is to be machined can be arranged. Provided additionally on the machining mount 11 are a rinsing chamber 12 and an electrolyte delivery line 15 that can be connected to a first electrolyte supply circuit 14 and is provided with an electrolyte delivery channel 16 for delivering electrolyte to the first and second working faces 31, 36 of the electrode 30.

A device 5 for the electrochemical machining of a component 20 has, in addition, a drive device 6 for movement of the electrode 30 relative to the component 20 to be machined. Furthermore, the device 5 has a supply device 7 for supplying the electrode 30 with energy and for supplying electrolyte to at least one gap 33 between the electrode 30 and the component 20, and a control device 9 for controlling the device 5 for the electrochemical machining of a component 20. During the machining of the component 20 by the first working face 31, the drive device 6 moves the electrode 30 in the direction of the arrow 29 opposite the component 20.

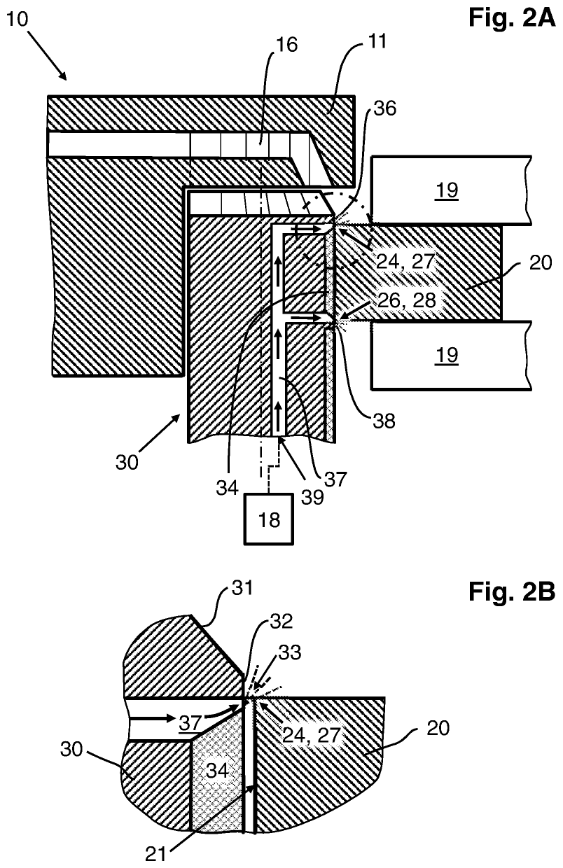

FIG. 2A shows the schematic illustration of the exemplary arrangement 10 according to the invention from FIG. 1 in a partial sectional depiction for carrying out a further, optional method step. In this case, the electrode 30 has an optional third working face 38, which is provided for arrangement at another edge 26 of the produced surface 21 (covered by the electrode 30) of the component 20 in order to remove at least one other structure 28 formed during the production of the surface 21 at this additional edge 26. Thus, the component 20 can simultaneously be machined with the second working face 36 and the third working face 38 of the electrode 30.

The second working face 36 and the third working face 38 are correspondingly arranged apart from each other at a distance A (depicted in FIG. 1) between the edge 24 and the other edge 26. In this way, the structures 27, 28 created in the form of edges in the exemplary embodiment can be removed by machining by the electrode 30 in parallel. Extending between the second working face 36 and the third working face 38 is an electrically nonconductive region 34, which can be designed alternatively also as a protective anode. On account of the electrically nonconductive region 34, which is arranged between the working faces 36 and 38, no material of the produced surface 21 of the component is electrochemically machined during the course of machining the edges 24, 26. In the exemplary embodiment, the distance A between the second working face 36 and the third working face 38 corresponds to the extension of the machining through the first working face 31 of the electrode 30. Depending on the desired rounding off, however, the distance can also be chosen to be larger or smaller.

Furthermore, in the electrode 20, electrolyte delivery channels 37 are formed, through which electrolyte can be delivered to the second working face 36 and—if present—the third working face 38. The electrolyte delivery channels 37 can be connected here to an electrolyte delivery line 39 that can be connected to a second electrolyte supply circuit 18 in order to deliver electrolyte to the second working face 36 and, in the exemplary embodiment, to the provided third working face 38 of the electrode 30.

FIG. 2B shows a detail of the illustration from FIG. 2A in the region of the removal of a structure 27 of the produced surface 21 formed at the edge 24 of the component 20. A voltage is applied between the second working face 36 (cathode) and the produced surface 21 of the component 20 (anode). An electrolyte is delivered through the depicted electrolyte delivery channel 37 to the machining gap 33, so that material is machined at the edge 24 of the component 20. In the illustrated exemplary design, a rounding off of the structure 27 occurs in the form of a machined edge at the edge 24.

FIG. 3 shows a schematic illustration of another exemplary arrangement 10 according to the invention for carrying out the method according to the invention for the electrochemical machining of a component 20 in a partial sectional depiction. The elements of the arrangement 10 for the electrochemical machining in FIG. 3 differ from the elements of the arrangement 10 for the electrochemical machining in the preceding figures in that the movement of advance of the electrode 30 exhibits an angle α with respect to the vertical and hence the machining occurs at an angle α to a vertically oriented component 20.

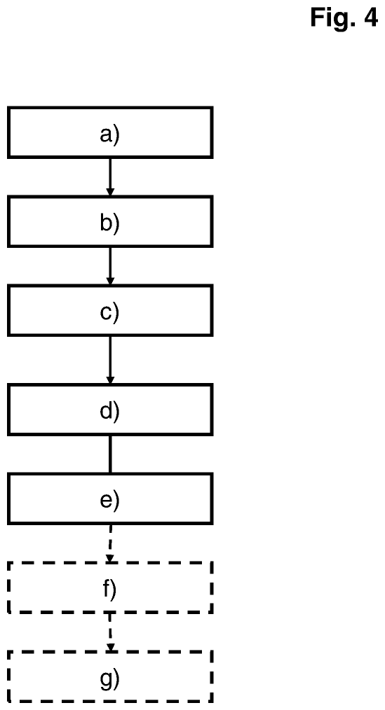

FIG. 4 shows a schematic illustration of a flow chart of the method according to the invention for the electrochemical machining of a component 20. In order to carry out the method, at least one electrode 30 is provided, which has a first working face 31 with an outer contour 32 that is shaped so as to form a gap 33 complementary to a surface 21 of the component 20 to be produced by the electrochemical machining. The electrode 30 further has a second working face 36, which can be arranged at an edge 24 of the produced surface 21 of the component 20 in order to remove by machining at least one structure 27 that is formed at the edge 24 thereof during the production of the surface 21.

The method according to the invention comprises the following steps: In a first step a), the component 20 is provided. In the second step b), the first working face 31 of the electrode 30 is positioned in a first machining position with respect to the component 20. In the third step c), the component is then machined with the first working face 31 by use of a first set of machining parameters for producing the surface 21. In the fourth step d), the machining of the component 20 with the first working face 31 is ended. This can occur at a predetermined position of the electrode 30 with respect to the component 20. In addition, the second working face 36 of the electrode 30 is positioned in this step at a predetermined position relative to the component 20. If the electrode 30 is positioned at a predetermined position relative to the component 20, then, in the fifth step e), the component 20 is machined with the second working face 36 by use of a second set of machining parameters for the removal by machining of the structure 27 that is formed on the edge 24 of the surface 21.

Optionally, it is possible in the proposed method to carry out two further method steps. In this case, the electrode 30 can have, for example, a third working face 38, which is arranged parallel to the second working face 36 at another edge 26 of the produced surface 21 of the component 20, and by means of which at least one structure 28 that is formed at the other edge 26 thereof during the production of the surface 20 can be removed by machining, whereby, in the further optional, sixth method step f), the component 20 can be machined simultaneously with the second working face 36 and the third working face 38 of the electrode 30.

In a further, likewise optional seventh method step g), the arrangement 10 has two electrolyte supply circuits 14, 18, whereby the machining of the component 20 with the first working face 31 of the electrode 30 is supplied with electrolyte by the first electrolyte supply circuit 14, and the machining of the component 20 with the second working face 36 and/or with the third working face 38 of the electrode 30 is supplied with electrolyte by the second electrolyte supply circuit 18.

1. A method for the electrochemical machining of a component with at least one electrode that has a first working face with an outer contour, which is shaped so as to form a gap complementary to a surface of the component that is to be produced by the electrochemical machining, and that has a second working face, which can be arranged at an edge of the produced surface of the component in order to remove by machining at least one structure that is formed during the production of the surface at the edge thereof, comprising the following method steps:
providing the component;
positioning the first working face of the electrode in a first machining position relative to the component;
machining the component with the first working face by use of a first set of machining parameters for producing the surface;
ending the machining of the component with the first working face, at a predetermined position and/or positioning the second working face of the electrode at a predetermined position relative to the component;
machining the component with the second working face by use of a second set of machining parameters for removing the structure.

2. The method for machining a component according to claim 1, wherein the electrode has at least one third working face, which is arranged parallel to the second working face at a further edge of the produced surface of the component and by which at least one structure that is formed during the production of the surface at the further edge thereof can be removed by machining, wherein the component is machined simultaneously with the second working face and the third working face of the electrode.

3. The method for machining a component according to claim 1, further comprising by two electrolyte supply circuits, wherein the machining of the component with the first working face of the electrode is supplied with electrolyte from the first electrolyte supply circuit and the machining of the component with the second and/or third working face(s) of the electrode is supplied with electrolyte by the second electrolyte supply circuit.

4. The method according to claim 1, further comprising the step of:
providing an electrode for the electrochemical machining of a component, including a first working face with an outer contour, which is shaped so as to form a gap complementary to a surface of the component that is to be formed by the electrochemical machining, and by a second working face, which is provided for arrangement at an edge of the produced surface of the component, in order to remove at least one structure formed during the production of the surface at this edge.

5. The method according to claim 4, wherein at least one third working face, which is provided for arrangement at a further edge of the produced surface of the component in order to remove at least one further structure that is formed during the production of the surface at this further edge.

6. The method according to claim 5, wherein the second working face and the third working face are spaced apart from each other corresponding to a distance between the edge and a further edge, so that structures formed there can be removed by machining in parallel with the electrode.

7. The method according to claim 6, wherein an electrically nonconductive region extends between the second working face and the third working face.

8. The method according to claim 5, wherein a distance between the second working face and the third working face corresponds to the extent of the machining by the first working face.

9. The method according to claim 4, wherein electrolyte delivery channels are formed in the electrode, through which electrolyte can be delivered to the second working face and/or the third working face.

10. The method according to claim 1, wherein at least one region of the component that is to be machined can be arranged at least partially, and which has a rinsing chamber and an electrolyte delivery line that can be connected to an electrolyte circuit for the delivery of electrolyte to the first working face of the electrode.

11. The method according to claim 10, further comprising the steps of:
providing at least one component mount for mounting a component that is to be machined in a device;
providing an electrode with at least one working face arranged thereon for machining a component;
providing a drive device for moving the at least one electrode relative to the component that is to be machined;
providing a supply device for supplying the electrode with energy and for supplying at least one gap between the electrode and the component with electrolyte; and
providing a control device for controlling the device for the electrochemical machining of a component.
